(19) United States
(12) Patent Application Publication
(10) Pub. No.: US 2014/0351547 A1
(43) Pub. Date: Nov. 27, 2014

(54) LINKED LIST FOR LOCK-FREE MEMORY ALLOCATION

(71) Applicant: International Business Machines Corporation, Armonk, NY (US)

(72) Inventors: Daniel J. Dietterich, Cambridge, MA (US); Maged M. Michael, Danbury, CT (US)

(21) Appl. No.: 13/932,641

(22) Filed: Jul. 1, 2013

Related U.S. Application Data
(63) Continuation of application No. 13/899,637, filed on May 22, 2013.

(51) Int. Cl. G06F 12/02

(52) U.S. Cl. CPC G06F 12/0284
USPC 711/170

(57) ABSTRACT

Embodiments relate to a linked list for memory allocation. An aspect includes maintaining a linked list of address ranges in a computer memory that are available for allocation. Another aspect includes receiving a request for allocation of a first address range, the request comprising a size of the first address range. Another aspect includes traversing the linked list to determine an available address range having a size that is greater than or equal to the size of the first address range. Another aspect includes determining whether there is interference in the linked list. Another aspect includes, based on determining that there is no interference in the linked list, removing determined address range from the linked list. Another aspect includes, based on determining that there is interference in the linked list, restarting the traversing of the linked list.

### CROSS-REFERENCE TO RELATED APPLICATION

This application is a continuation of U.S. application Ser. No. 13/899,637 filed on May 22, 2013, which is herein incorporated by reference in its entirety.

### BACKGROUND

This disclosure relates generally to computer memory, and more particularly to a linked list for lock-free memory allocation in a computer memory.

A computer system may execute a relatively large number of operations concurrently. These operations may require allocation of ranges of addresses in the computer memory for exclusive use during execution. To perform concurrent memory allocation, the computer system allocates and deallocates ranges of addresses in the computer memory to various operations during execution. An allocated range in the computer memory may be locked to a particular operation by the computer system during execution of the operation. However, for high-availability computer systems, such locking may not be a viable option, as errors may occur in the computer system due to the failure or stoppage of an operation that is a lock holder.

The addresses in the computer memory that are available for allocation by the computer system may be divided into fixed, equally-sized address ranges, which may be allocated among operations in a lock-free and highly-available manner. However, such fixed-sized address ranges do not allow flexibility in allocation of memory space to operations, and also may not be suited for handling of operations that require relatively large address ranges for execution.

### SUMMARY

Embodiments relate to a method for a linked list for memory allocation. An aspect includes maintaining, by a memory allocation module in a computer processor, a linked list of address ranges in a computer memory that are available for allocation. Another aspect includes receiving, by the memory allocation module, a request for allocation of a first address range from a first operation, the request comprising a size of the first address range. Another aspect includes traversing the linked list to determine an available address range having a size that is greater than or equal to the size of the first address range. Another aspect includes determining whether there is interference in the linked list from a second operation. Another aspect includes, based on determining that there is no interference in the linked list from the second operation, removing determined address range from the linked list. Another aspect includes, based on determining that there is interference in the linked list from the second operation, restarting the traversing of the linked list.

Additional features are realized through the techniques of the present exemplary embodiment. Other embodiments are described in detail herein and are considered a part of what is claimed. For a better understanding of the features of the exemplary embodiment, refer to the description and to the drawings.

### BRIEF DESCRIPTION OF THE SEVERAL VIEWS OF THE DRAWINGS

Referring now to the drawings wherein like elements are numbered alike in the several Figures:

FIG. 1 is a block diagram illustrating an embodiment of a computer system for use in conjunction with a linked list for lock-free memory allocation.

FIG. 2 is a block diagram illustrating an embodiment of a linked list for lock-free memory allocation.

FIG. 3 is a flowchart illustrating an embodiment of a method for adding a free range to a linked list for lock-free memory allocation.

FIG. 4 is a flowchart illustrating an embodiment of a method for allocating an address range using a linked list for lock-free memory allocation.

FIG. 5 is a flowchart illustrating an embodiment of a method for cleanup of a linked list for lock-free memory allocation.

FIG. 6 is a flowchart illustrating another embodiment of a method for adding a free range to a linked list for lock-free memory allocation.

FIG. 7 is a flowchart illustrating another embodiment of a method for allocating an address range using a linked list for lock-free memory allocation.

FIG. 8 is a flowchart illustrating another embodiment of a method for cleanup of a linked list for lock-free memory allocation.

FIG. 9 is a block diagram illustrating an embodiment of a computer system for use in conjunction with a linked list for lock-free memory allocation.

### DETAILED DESCRIPTION

Embodiments of a linked list for lock-free memory allocation are provided, with exemplary embodiments being discussed below in detail. The ranges of addresses in the computer memory that are available for allocation may be managed as a sorted linked list by a memory allocator of the computer system. Each node in the linked list represents a contiguous range of available, or free, memory. The memory allocator manages the linked list without locking any portion of the computer memory, allowing concurrent operations to proceed unimpeded. The computer system that implements the linked list for memory allocation is highly available, and stoppage or failure of an operation does not block other operations from proceeding with execution. Use of locking is avoided by detection of interference between operations to which address ranges are allocated and deallocated using the linked list, in order to maintain an accurate list of available address ranges in the linked list. If such interference is detected, traversal of the linked list is restarted in order to maintain a consistent view of the linked list. The interference may be detected by comparing a value that is stored in the linked list to an expected value. If the stored and expected values do not match, interference is indicated.

The memory allocator may process requests for memory allocation from various operations by interacting with the nodes in the linked list in a consistent manner, so as to maintain an accurate depiction by the linked list of the ranges of addresses that are available for allocation in the computer memory. The available ranges are represented as a sorted linked list of address ranges, with each node in the linked list representing a continuous range having a range start and a range end. Each node also includes a pointer to a next node in the linked list. A free range that has been deallocated, and that is now free for allocation to another operation, may be added to the linked list to an existing node that represents an address range that is contiguous to the free range, or as a new node that is inserted in the linked list at a position that is determined by the addresses of the free range. Ranges of addresses may be allocated following a first fit policy, i.e. a continuous range having a lowest address in the linked list that is of a sufficient size to accommodate a memory allocation request may be allocated to that operation that issued the memory allocation request.

Operations that have been allocated a memory range may complete, fail, or be stopped at any time. Therefore, in order to maintain an accurate reflection of the state of the allocations in the memory, cleanup is performed on the linked list in conjunction with the address range allocation and deallocation. Whether there is interference between operations is determined in conjunction with the cleanup, and if interference is detected, traversal of the linked list is restarted in order to maintain a consistent view of the linked list. Nodes are removed from the list by a series of steps to maintain consistency among concurrent operations. First, it is determined if a node's range start and range end values are equal, indicating an empty range. Then the next pointer of the node is marked as ready for deletion. Lastly, the node is removed by changing the next pointer of its preceding node to point to the node after the removed node. If an operation empties the range of a node, or marks a node for removal, and is then stopped before the node is removed, a subsequent operation may remove the empty or marked node. Adjacent nodes in the linked list that define contiguous ranges may also be consolidated, or merged, into a single node. A memory management method, such as reference counting, hazard pointers, read-copy-update, may also be applied to the nodes that make up the linked list in some embodiments.

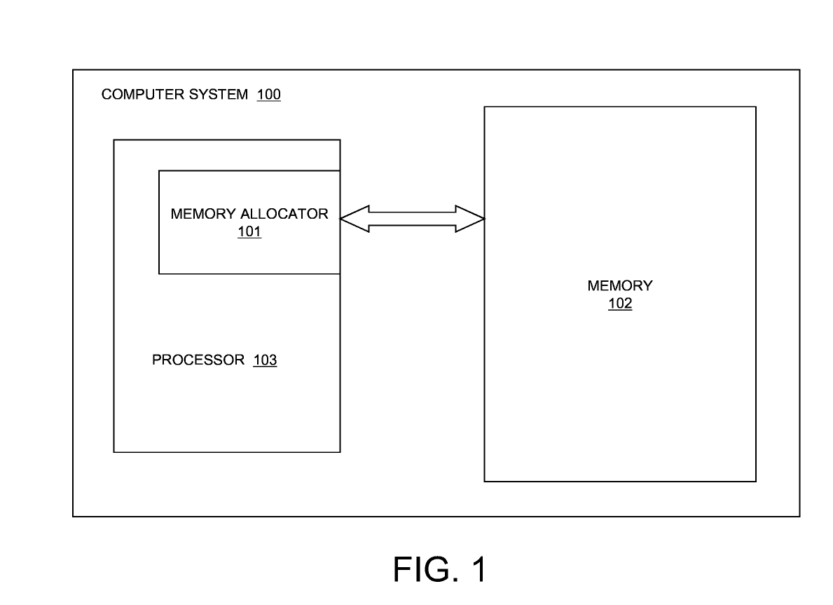

FIG. 1 illustrates an embodiment of a computer system 100 for use in conjunction with a linked list for lock-free memory allocation. Computer system 100 includes a processor 103 that interacts with a memory 102 to execute operations. Memory allocator 101 allocates ranges of addresses in memory 102 based on memory allocation requests that are issued by the operations in the course of execution. The ranges of addresses in memory 102 are deallocated by memory allocator 101 based on completion, failure, or stoppage of operations; a deallocated range of addresses may then be allocated by memory allocator 101 to another operation. A memory allocation request may be issued to memory allocator 101 by any appropriate operation. For example, in various embodiments, an operation that issues a memory allocation request may be executing on a remote computer that is connected to computer system 100 via a network, or a memory allocation request may be issued by an operation that is executed directly by processor 103 of computer system 100. The memory allocator 101 maintains a linked list to track address ranges that are available for allocation in memory 102.

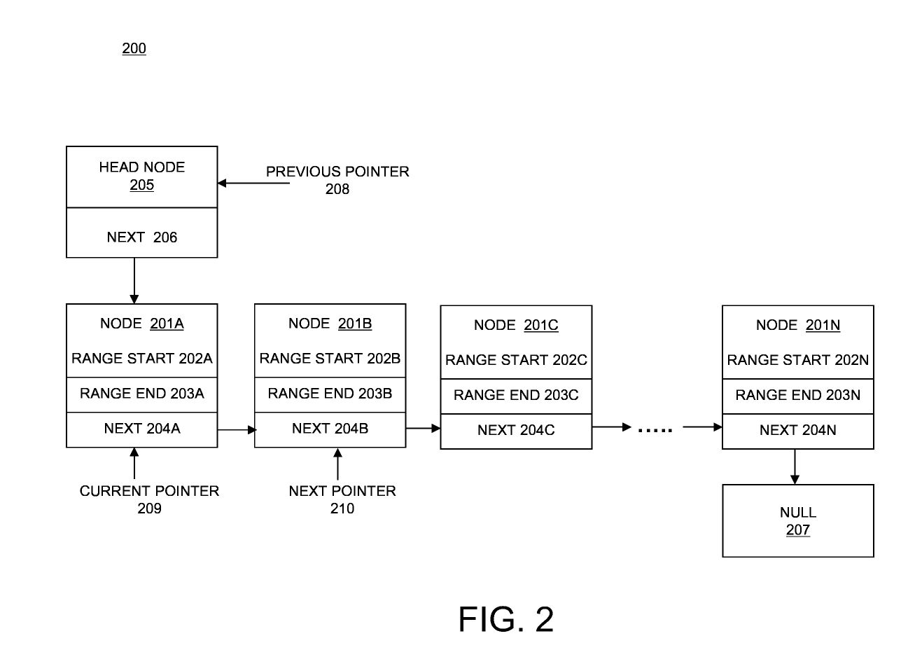

An embodiment of a linked list 200 that may be implemented in memory allocator 101 is shown in FIG. 2. Linked list 200 includes a plurality of nodes 201A-N, each representing a continuous range of memory that is available for allocation in memory 102. Each of nodes 201A-N includes a range start 202A-N and range end 203A-N that define starting and ending addresses of the continuous range of memory represented by the node 201A-N, and a next field 204A-N comprising a pointer that references the next node in the linked list 200. In each node of nodes 201A-N, the range end 203A-N is equal to the corresponding range start 202A-N plus the range size of the address range represented by the node of nodes 102A-N. The nodes 102A-N are sorted sequentially, i.e., the range end 203A-N of a node 201A-N is lower than the range start 202A-N of the next node that is referenced by the node's next field 204A-N (for example, range end 203A is lower than range start 202B). The start of the list is defined by head node 205, which comprises a next field 206 that references the first node 201A in the linked list 200. The next field 204N in the last node 201N in the linked list 200 references null 207. Nodes may be updated, added, and removed from linked list 200 based on allocation and deallocation of address ranges in memory 102 by memory allocator 101, and cleanup of the linked list 200 is also performed in conjunction with the allocation and deallocation. In some embodiments, previous pointer 208, current pointer 209, and next pointer 210, may be used by memory allocator 101 to move through the linked list 200 during allocation, deallocation, and cleanup. In FIG. 2, previous pointer 208 references head node 205; current pointer 209 references node 201A, and next pointer 210 references node 201B; however, this is shown for illustrative purposes only. Previous pointer 208, current pointer 209, and next pointer 210 may point to any three consecutive nodes of nodes 201A-N in the linked list 200. Further, a linked list 200 may include any appropriate number of nodes.

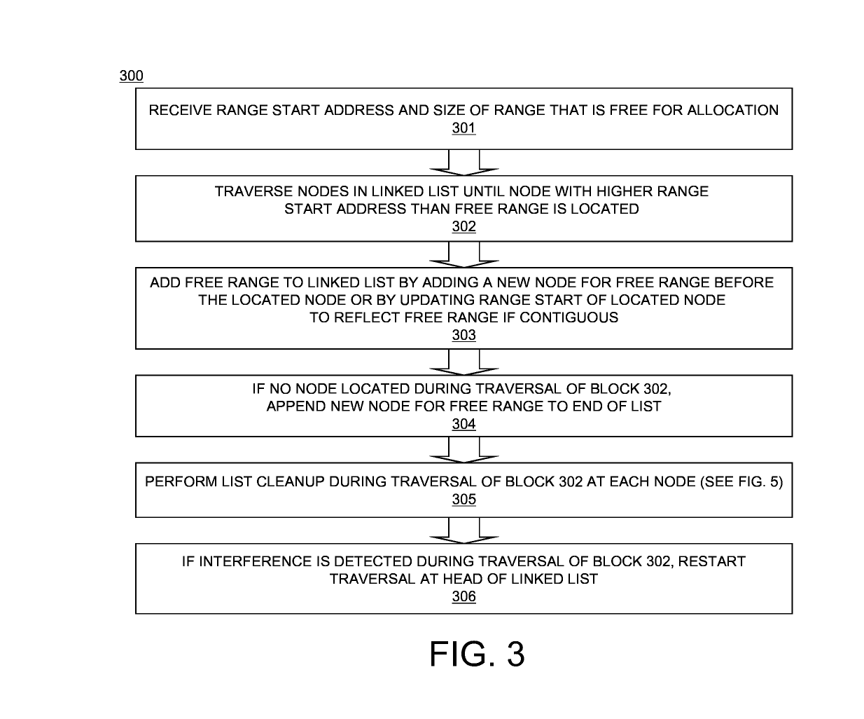

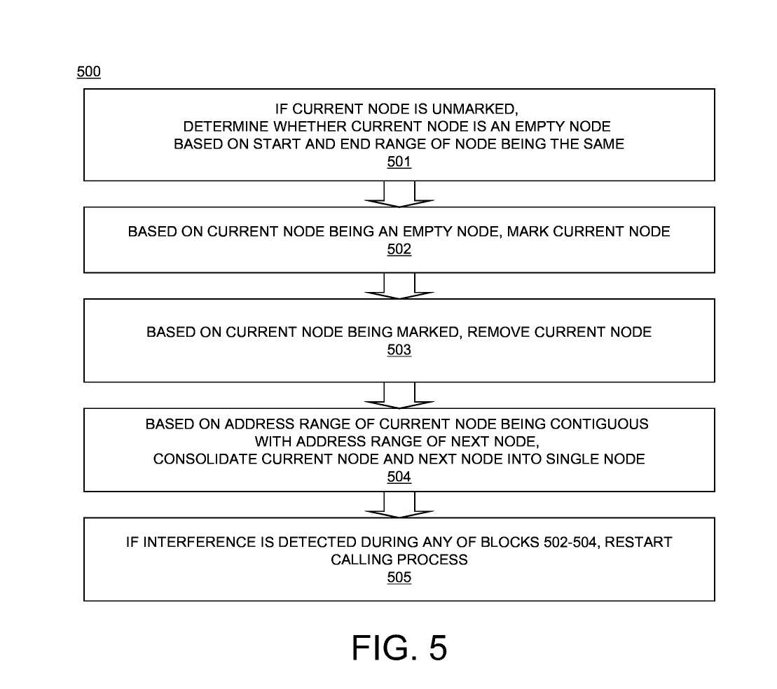

FIG. 3 is a flowchart illustrating an embodiment of a method 300 for adding a deallocated range to a linked list for lock-free memory allocation. FIG. 3 is discussed with respect to FIGS. 1 and 2, and may be implemented in memory allocator 101. First, in block 301, a range start address and either a range end address or a range size of an address range in memory 102 that has been deallocated and is free for allocation to another operation (due to, for example, completion, stoppage, or failure of an operation) are received by memory allocator 101. In block 302, the nodes 201A-N in the linked list 200 are traversed in order, starting from head node 205, until a node having a higher range start 202A-N than the range start address that was received in block 301 is located. Then, in block 303, if a node was located in block 302, the free range is either added to the located node by updating the range start of the located node if the free range and the range defined by the located node are contiguous, or a new node that defines the free range is added to the linked list 200. The new node may be added before the located node. In block 304, if no node was located in block 302, a new node defining the free range is added after the last node 201N in the linked list 200; the next field of the new node is set to reference null 207. In block 305, during the traversal of block 302, cleanup procedures are performed at each node of nodes 102A-N; the cleanup procedures of block 305 are described in further detail below with respect to FIG. 5. Lastly, in block 306, if interference from another operation is detected during the traversal of block 302, the traversal of block 302 is restarted, in order to maintain a consistent view of the linked list 200 and its contents. For example, interference may be detected by comparing a value that is stored in the linked list, such as a range start 202A-N, a range end 203A-N, or a next field 204A-N, to an expected value. If the stored and expected values do not match, interference in the linked list 200 by another operation may be indicated. In some embodiments, the deallocation method 300 of FIG. 3 may be implemented as a module that receives a range start address and either a range end address or a range size of an address range in memory 102 that is free for allocation as parameters, and does not return a value.

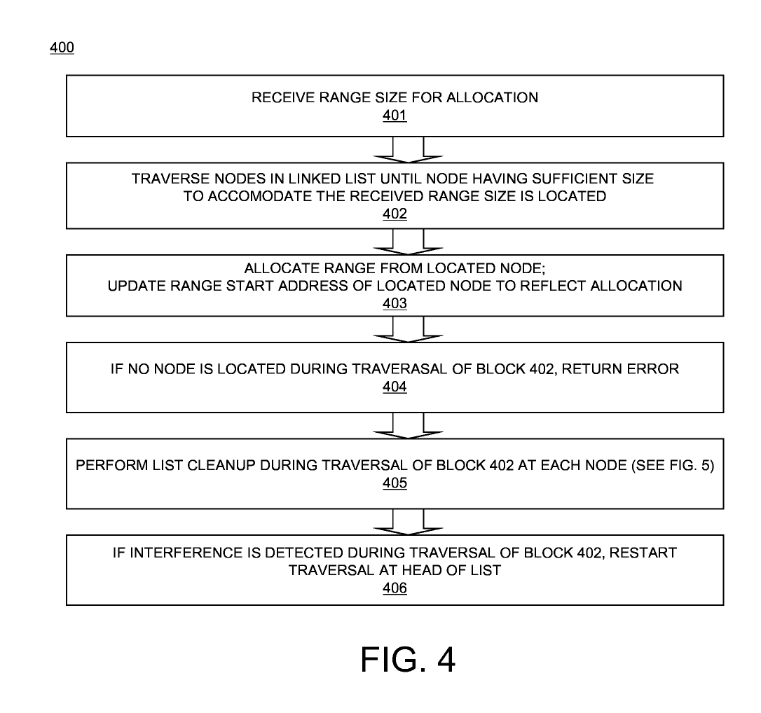

FIG. 4 is a flowchart illustrating an embodiment of a method 400 for allocating an address range using a linked list for lock-free memory allocation. FIG. 4 is discussed with respect to FIGS. 1 and 2, and may be implemented in memory allocator 101. First, in block 401, a memory allocation request including a requested range size is received by memory allocator 101. In block 402, the nodes 201A-N of the linked list 200 are traversed in order, starting from head node 205, until a node having a sufficient range size to accommodate the requested range size is located (i.e., a node in which the range end minus the range start is larger than the requested range size). Then, in block 403, if a node was located in block 402, an address range is allocated for the memory allocation request from the located node, and the range start of the located node is updated to reflect the allocation by adding the requested range size to the range start of the located node. In block 404, if no node was located in the linked list 200 having a sufficient range size to accommodate the requested range size during the traversal of block 402, an error is returned. In block 405, during the traversal of block 402, cleanup procedures are performed at each node of nodes 102A-N; the cleanup procedures of block 405 are described in further detail below with respect to FIG. 5. Lastly, in block 406, if interference is detected during the traversal of block 402, the traversal of block 402 is restarted, in order to maintain a consistent view of the linked list 200 and its contents. For example, interference may be detected by comparing a value that is stored in the linked list, such as a range start 202A-N, a range end 203A-N, or a next field 204A-N, to an expected value. If the stored and expected values do not match, interference in the linked list 200 by another operation may be indicated. In some embodiments, the allocation method 400 of FIG. 4 may be implemented as a module that receives a range size as a parameter, and returns an address of an allocated range or an error code.

FIG. 5 is a flowchart illustrating an embodiment of a method 500 for cleanup of a linked list for lock-free memory allocation. Method 500 acts to consolidate nodes having contiguous ranges into a single node, and also to remove empty nodes from the linked list 200. Method 500 is performed in conjunction with method 300 of FIG. 3 and method 400 of FIG. 4, and may be performed at each node during the in-order traversal of linked list 200 of blocks 302 and 402. First, in block 501, if the current node is unmarked, it is determined whether the current node is an empty node by comparing the range start to the range end. If the range start and range end are the same, the current node is determined to be empty. Then, in block 502, if the current node is empty, it is marked for removal. The mark may be placed in the next field of the current node. Flow then proceeds to block 503, in which, if the current node is marked, it is removed. Removal may be performed by updating the next field of the previous node to the current node to reference the next node to the current node in linked list 200. In block 504, it is determined whether the range of the current node and its next node are contiguous; if the current node and next node are determined to have contiguous ranges, the current node and next node are consolidated into a single node. The consolidation may be performed by updating the range start of the next node to be equal to the range start of the current node, and then removing the current node from the linked list 200. Lastly, in block 505, if interference is detected during any of blocks 502, 503, or 504, calling process (i.e., method 300 of FIG. 3 or method 400 of FIG. 4) is restarted, in order to maintain a consistent view of the linked list 200 and its contents. For example, interference may be detected by comparing a value that is stored in the linked list, such as a range start 202A-N, a range end 203A-N, or a next field 204A-N, to an expected value. If the stored and expected values do not match, interference in the linked list 200 by another operation may be indicated.

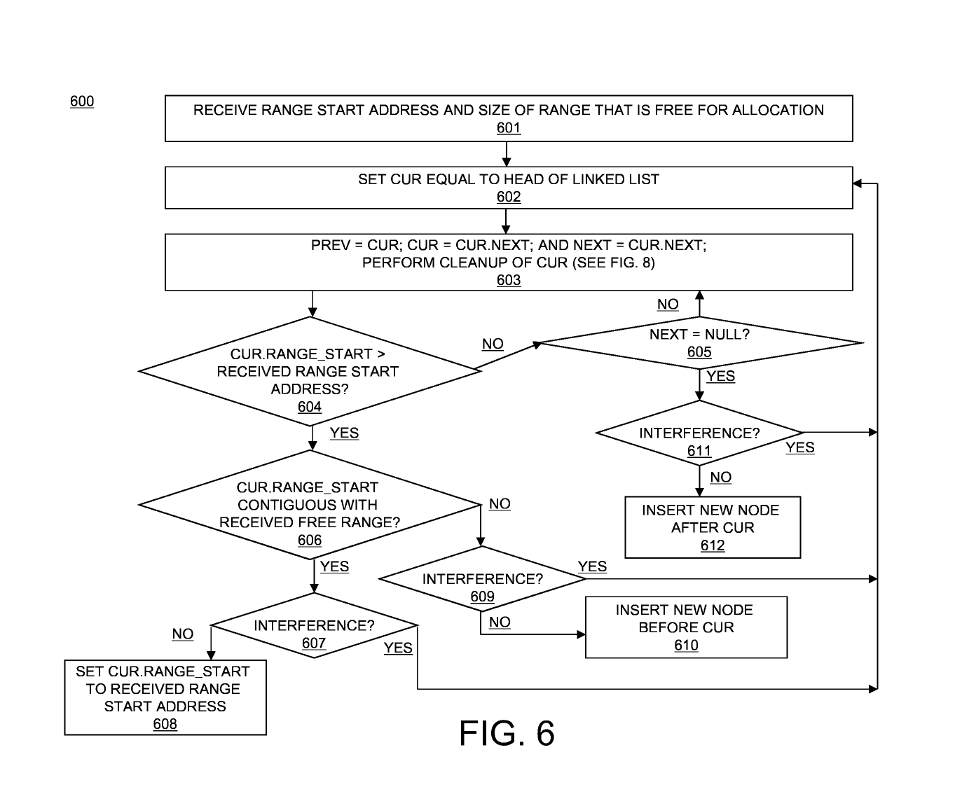

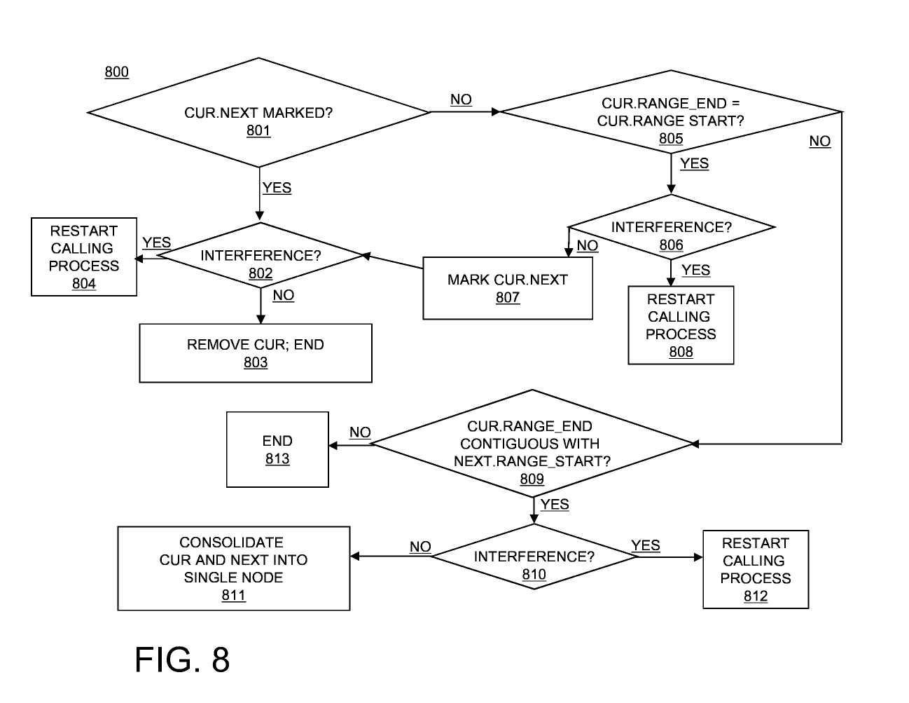

FIG. 6 is a flowchart illustrating an embodiment of a method 600 for adding a free range to a linked list for lock-free memory allocation using previous pointer 208, current pointer 209, and next pointer 210 that were shown in FIG. 2. FIG. 6 is discussed with respect to FIGS. 1 and 2, and may be implemented in memory allocator 101. First, in block 601, a range start address and either a range end address or a range size of an address range in memory 102 that has been deallocated and is free for allocation to another operation (due to, for example, completion, stoppage, or failure of an operation) are received by memory allocator 101. Then, in block 602, a current pointer 209 (CUR) is set equal to the head node 205 of the linked list 200. Flow then proceeds to block 603, in which previous pointer 208 (PREV) is set equal to current pointer 209; the current pointer 209 is set equal to the node in the linked list 200 that is referenced by the next field 204A-N of the current node (i.e., CUR.NEXT); and then the next pointer 210 (NEXT) is set equal to CUR.NEXT. For example, in the first iteration of block 603, previous pointer 208 is set equal to head node 205; then current pointer 209 is set, based on next field 206, equal to node 201A; and then next pointer 210 is set, based on next field 204A, equal to node 201B. Cleanup operations are performed on the node referenced by the current pointer 209 during block 603; these cleanup operations are discussed below with respect to FIG. 8.

Flow then proceeds to block 604, in which it is determined whether the range start 202A-N of the node referenced by the current pointer 209 (i.e., CUR.RANGE_START) is greater than the range start address of the free range that was received in block 601. If it is determined in block 604 that the CUR.RANGE_START is less than the received range start address, flow proceeds from block 604 to block 605, in which it is determined whether NEXT is equal to null 207. If it is determined in block 605 that the NEXT is not equal to null 207, flow returns from block 605 to block 603, and traversal of the linked list 200 continues by setting previous pointer 208 (PREV) to current pointer 209; the current pointer 209 is set equal to CUR.NEXT; and then the next pointer 210 (NEXT) is set equal to CUR.NEXT. Cleanup is also performed on CUR as described in FIG. 8. However, if it was determined in block 605 that NEXT is equal to null 207, then flow proceeds from block 605 to block 611, in which it is determined whether there is interference in the linked list 200 by another operation. Interference may be determined to exist if PREV.NEXT is not equal to CUR in block 611 in some embodiments. If it is determined in block 611 that there is no interference, flow proceeds from block 611 to block 612, in which a new node corresponding to the free range is added to the linked list 200 after CUR (for example, node 210N). CUR.NEXT is set to reference the new node, and the next field 204N of the new node is set equal to null 207. However, if it is determined in block 611 that there is interference, flow proceeds from block 611 to block 602, and traversal of the linked list 200 restarts.

If it was determined in block 604 that CUR.RANGE_START is greater than the received range start address, flow proceeds from block 604 to block 606, in which it is determined whether the range defined by CUR is contiguous with the free range, i.e., whether the range end address of the free range directly precedes CUR.RANGE_START in the memory 102. If it is determined in block 606 that CUR.RANGE_START is contiguous with the free range, flow proceeds from block 606 to block 607, in which it is determined whether there is interference in the linked list 200 by another operation. Interference may be determined to exist if CUR.START is not equal to an expected range start value for CUR in block 607 in some embodiments. If it is determined in block 607 that there is no interference, flow proceeds from block 607 to block 608, in which CUR.RANGE_START set equal to the received range start address. However, if it is determined in block 607 that there is interference, flow proceeds from block 607 to block 602, and traversal of the linked list 200 restarts.

If it was determined in block 606 that CUR.RANGE_START is not contiguous with the free range, flow proceeds from block 606 to block 609, in which it is determined whether there is interference in the linked list 200 by another operation. Interference may be determined to exist if PREV.NEXT is not equal to CUR in block 609 in some embodiments. If it is determined in block 609 that there is no interference, flow proceeds from block 609 to block 610, in which a new node corresponding to the free range is added to the linked list 200 after PREV and before CUR. PREV.NEXT is set equal to the new node, and the next field of the new node is set equal to CUR. However, if it is determined in block 609 that there is interference, flow proceeds from block 609 to block 602, and traversal of the linked list 200 restarts.

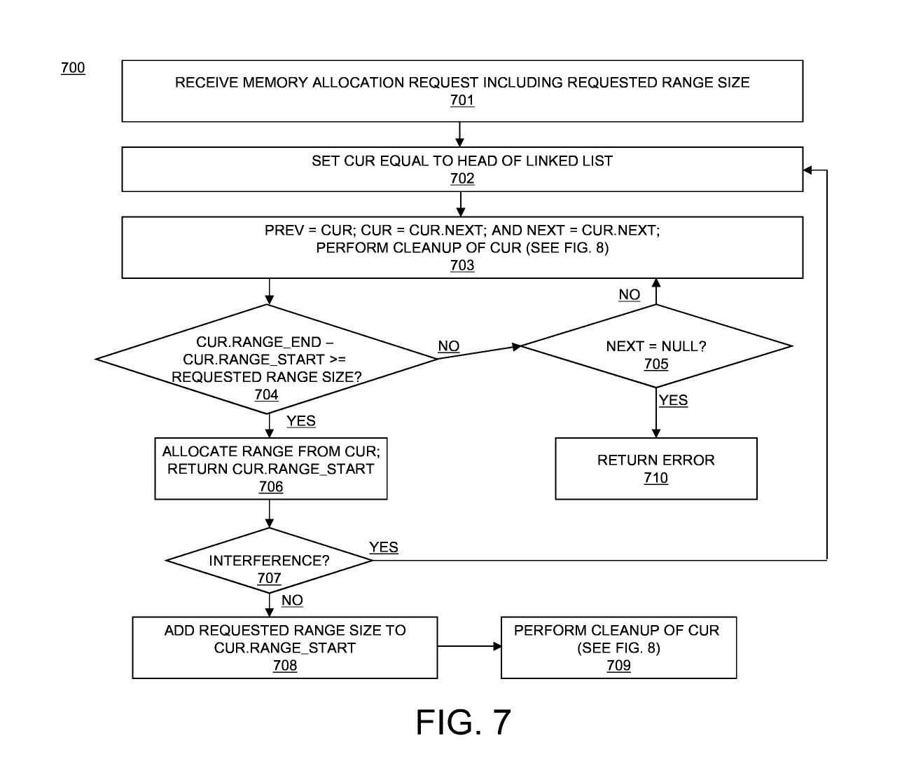

FIG. 7 is a flowchart illustrating a embodiment of a method 700 for allocating a memory block using a linked list for lock-free memory allocation using previous pointer 208, current pointer 209, and next pointer 210 that were shown in FIG. 2. FIG. 7 is discussed with respect to FIGS. 1 and 2, and may be implemented in memory allocator 101. First, in block 701, a memory allocation request including a requested range size is received by memory allocator 101. Next, in block 702, a current pointer 209 (CUR) is set equal to the head node 205 of the linked list 200. Then, in block 703, previous pointer 208 (PREV) is set equal to current pointer 209; the current pointer 209 is set equal to the node in the linked list 200 that is referenced by the next field 204A-N of the current node (i.e., CUR.NEXT); and then the next pointer 210 (NEXT) is set equal to CUR.NEXT. For example, in the first iteration of block 703, previous pointer 208 is set equal to head node 205; then current pointer 209 is set, based on next field 206, equal to node 201A; and then next pointer 210 is set, based on next field 204A, equal to node 201B. Cleanup operations are performed on the node referenced by the current pointer 209 during block 703; these cleanup operations are discussed below with respect to FIG. 8.

Flow then proceeds to block 704, in which it is determined whether the size of the address range defined by CUR (i.e., CUR.RANGE-END minus CUR.RANGE_START) is greater than the requested range size that was received in block 701. If it is determined in block 704 that CUR.RANGE-END minus CUR.RANGE_START is less than the requested range size, CUR cannot accommodate the memory allocation request, and flow proceeds to from block 704 to block 705, in which it is determined whether NEXT is equal to null 207. If it is determined in block 705 that NEXT is not equal to null 207, flow returns from block 705 to block 703, and traversal of the linked list 200 continues by setting previous pointer 208 (PREV) to current pointer 209; the current pointer 209 is set equal to CUR.NEXT; and then the next pointer 210 (NEXT) is set equal to CUR.NEXT. Cleanup is also performed on CUR as described in FIG. 8. However, if it is determined in block 705 that NEXT is equal to null 207 (e.g., CUR is node 201N that was shown in FIG. 2), flow proceeds from block 705 to block 710, an error indicating that no range of sufficient size is available in memory 102 for the memory allocation request received in block 701, and method 700 ends.

If it was determined in block 704 that CUR.RANGE-END minus CUR.RANGE_START is greater than or equal to the requested range size, flow proceeds to from block 704 to block 706, in which the memory allocation request is satisfied from the range indicated by CUR, and CUR.RANGE_START is returned to indicate the start address of the allocated range. Next, in block 707, it is determined whether there is interference in the linked list 200 by another operation. Interference may be determined to exist if CUR.START is not equal to an expected range start value for CUR in block 707 in some embodiments. If it is determined in block 707 that there is no interference, flow proceeds from block 707 to block 708, in which the requested range size is added to CUR.RANGE_START to reflect the allocation of the requested range size. Then, flow proceeds to block 709, in which cleanup of CUR is performed as described in FIG. 8, so as to remove the CUR from the linked list 200 if the current node is empty after the allocation of block 706. However, if it is determined in block 707 that there is interference, flow proceeds from block 707 to block 702, and traversal of the linked list 200 restarts.

FIG. 8 is a flowchart illustrating an embodiment of a method 800 for cleanup of a current node (CUR) in a linked list for lock-free memory allocation. Method 800 may be performed in conjunction with block 603 of FIG. 6, or blocks 703 and 709 of FIG. 7. First, in block 801, it is determined whether the next field 204A-N (i.e., CUR.NEXT) of CUR indicates that CUR is marked for removal. If it is determined in block 801 that CUR.NEXT indicates that CUR is marked for removal, flow proceeds to block 802, in which it is determined whether there is interference in the linked list 200 by another operation. Interference may be determined to exist if PREV.NEXT is not equal to CUR in block 802 in some embodiments. If it is determined in block 802 that there is no interference, flow proceeds from block 802 to block 803, in which CUR is removed, and method 800 ends. CUR may be removed in block 803 by setting PREV.NEXT equal to NEXT. However, if it is determined in block 802 that there is interference, flow proceeds from block 802 to block 804, and the calling process, i.e., method 600 of FIG. 6, or method 700 of FIG. 7, is restarted at block 602 or 702, respectively.

If it was determined in block 801 that the current node is unmarked, flow proceeds from block 801 to block 805, in which it is determined whether CUR is an empty node based on CUR.RANGE START being equal to CUR.RANGE_END. If CUR.RANGE START is equal to CUR.RANGE_END, the current node is determined to be empty, and flow proceeds to from block 805 to block 806, in which it is determined whether there is interference in the linked list 200 by another operation. Interference may be determined to exist if CUR.NEXT is not equal to NEXT in block 806 in some embodiments. If it is determined in block 806 that there is no interference, flow proceeds from block 806 to block 807, in which CUR is marked for removal. The mark may be placed in CUR.NEXT. Flow then proceeds from block 807 to block 802, which proceeds as described above. However, if it is determined in block 806 that there is interference, flow proceeds from block 806 to block 808, and the calling process, i.e., method 600 of FIG. 6, or method 700 of FIG. 7, is restarted at block 602 or 702, respectively.

If, in block 805, it was determined that CUR.RANGE START is not equal to CUR.RANGE_END, flow proceeds from block 805 to block 809, in which it is determined whether the address range of the CUR and the address range of the NEXT are contiguous. The address range of the CUR and the address range of the NEXT are contiguous if CUR.RANGE_END directly precedes NEXT.RANGE_START in memory 102. If CUR and NEXT are determined to have contiguous ranges in block 809, flow proceeds to from block 809 to block 810, in which it is determined whether there is interference in the linked list 200 by another operation. Interference may be determined to exist if CUR.START is not equal to an expected range start value for CUR in block 810 in some embodiments. If it is determined in block 810 that there is no interference, flow proceeds from block 810 to block 811, in which CUR and NEXT are consolidated into a single node. The consolidation may be performed by setting NEXT.RANGE_START equal to CUR.RANGE_START and then setting PREV.NEXT to reference NEXT, removing CUR from the linked list 200. However, if it is determined in block 810 that there is interference, flow proceeds from block 810 to block 812, and the calling process, i.e., method 600 of FIG. 6, or method 700 of FIG. 7, is restarted at block 602 or 702, respectively. If CUR and NEXT were determined not to have contiguous ranges in block 809, flow proceeds from block 809 to block 813, and method 800 ends.

In some embodiments, the methods of FIGS. 3-8 may be implemented in memory allocator 101 as a software library that is used by application programs that are executed by processor 103 in computer system 100 of FIG. 1, or by a remote computer that is connected to computer system 100 via a network, to request allocation of an address range in memory 102. Tables 1-8 below illustrate examples of pseudocode implementing the methods of FIGS. 3-8 that are discussed above. Add_range is illustrated in Table 1 and corresponds to FIGS. 3, 5, 6, and 8, and Allocate_range is illustrated in Table 2 and corresponds to FIGS. 4, 5, 7, and 8. Supporting functions that are used by Add_range and Allocate_range are also illustrated, including Insert_new_node (Table 3), Remove_marked_cur (Table 4), Validate_prev (Table 5), Remove_zero_size (Table 6), Update_cur_range (Table 7), and Compare_and_swap (Table 8). Interference is detected by the Compare_and_swap (CAS) pseudocode that is shown in Table 8; determination of interference by CAS results in restarting of Add_range or Allocate_range.

TABLE 1
Pseudocode for Add range

```
Add_range (start, size)
      if (size == 0) return
      node = new_node(start,size);
start_over:
prev = Head;
cur = prev.next;
loop
      if (cur == NULL) if (insert_new_node(node,prev,cur)) return
else goto start_over;
      next = cur.Next;
      if (next & 0x1) { /* Marked node*/
            unmarked_next = next & (~0x1);
            if (!remove_marked_cur(prev,cur,unmarked_next)) goto
      start_over;
            cur = unmarked_next;
      } else { /* ! Marked */
            cur_start = cur.start;
            cur_end = cur.end;
            if (!validate_prev(prev,cur)) goto start_over;
            if (cur_start == cur_end) {
                  if (!remove_zero_size(prev,cur,next))
                  goto start_over;
                  cur = next;
            } else { /* cur_start < cur_end */
                    if (start < cur_start) { /* Found */
                        if (start+size == cur_start) { /* Prepend
                        to cur
                  range */
                              if (update_cur_range(cur,start,start+
                              size))
                              return else goto start_over;
                        } else { /* Insert a new node */
                              if (insert_new_node(prev,cur,start,
                              size))
                        return else goto start_over;
                        }
                  } else { /* continue to the next node */
                        prev = cur;
                        cur = next;
                  }
            }
      }
}
```

TABLE 2
Pseudocode for Allocate range

```
Allocate_range(size) : address
start_over:
      prev = Head;
      cur = prev.next;
      loop /* traversing */
            if (cur == NULL) return OUT_OF_MEMORY;
            next = cur.next;
            if (next & 0x1) { /* Marked node*/
                  unmarked_next = next & (~0x1);
                  if (!remove_marked_cur(prev,cur,
                  unmarked_next)) goto
            start_over;
                  cur = unmarked_next;
            } else { /* ! Marked */
                  cur_start = cur.start;
                  cur_end = cur.end;
                  if (!validate_prev(prev,cur)) goto start_over;
                  if (cur_start == cur_end) {
                        if (!remove_zero_size(prev,cur,next))
                        goto start_over;
                        cur = next;
                  } else { /* cur_size > 0 */
                        if (size <= cur_end − cur_start) {
                        /* Found */
                  if (!CAS(&cur.start,cur_start,cur_start+size)) goto
            start_over);
                  if (cur_end − cur_start == size remove_zero_size
            (preve.cur.next);
                  return cur_start;
            } else { /* continue to the next node */
                  prev = cur;
                  cur = next;
            }
      }
}
```

TABLE 3
Pseudocode for Insert new node

Insert_new_node(node,prev,cur) : boolean node.next = cur;
return CAS(&prev.next,cur,node);

TABLE 4
Pseudocode for Remove marked cur

Remove_marked_cur(prev,cur,next) : Boolean
return CAS(&prev.next,cur,next);

TABLE 5
Pseudocode for Validate prev

Validate_prev(prev,cur) : Boolean
return (prev.next == cur);

TABLE 6
Pseudocode for Remove zero size

```
Remove_zero_size(prev,cur,next) : Boolean
      marked_next = next | 0x1;
      if (!CAS(&cur.next,next,marked_next)) return false;
      return remove_marked_cur(prev,cur,next);
```

TABLE 7
Pseudocode for Update cur range

Update_cur_range(cur,start,end) : Boolean
return CAS(&cur.start,end,start);

TABLE 8
Pseudocode for Compare and swap (CAS)

```
CAS(addr, expectedval, newval): Boolean
      atomically
            if (*addr == expectedval){
                  *addr = newval;
                  return true;
            } else {
                  return false;
      }
```

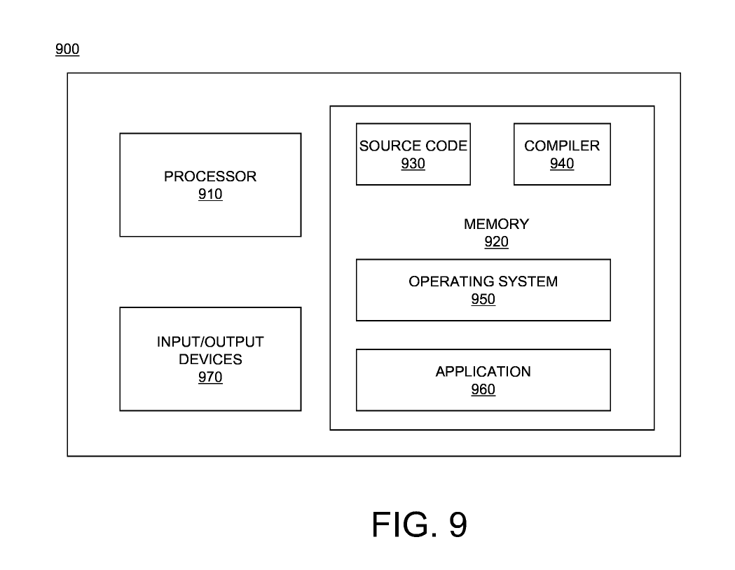

FIG. 9 illustrates an example of a computer 900 which may be utilized in conjunction with exemplary embodiments of a linked list for memory allocation. Various operations discussed above may utilize the capabilities of the computer 900. One or more of the capabilities of the computer 900 may be incorporated in any element, module, application, and/or component discussed herein.

The computer 900 includes, but is not limited to, PCs, workstations, laptops, PDAs, palm devices, servers, storages, and the like. Generally, in terms of hardware architecture, the computer 900 may include one or more processors 910, memory 920, and one or more I/O devices 970 that are communicatively coupled via a local interface (not shown). The local interface can be, for example but not limited to, one or more buses or other wired or wireless connections, as is known in the art. The local interface may have additional elements, such as controllers, buffers (caches), drivers, repeaters, and receivers, to enable communications. Further, the local interface may include address, control, and/or data connections to enable appropriate communications among the aforementioned components.

The processor 910 is a hardware device for executing software that can be stored in the memory 920. The processor 910 can be virtually any custom made or commercially available processor, a central processing unit (CPU), a digital signal processor (DSP), or an auxiliary processor among several processors associated with the computer 900, and the processor 910 may be a semiconductor based microprocessor (in the form of a microchip) or a macroprocessor.

The memory 920 can include any one or combination of volatile memory elements (e.g., random access memory (RAM), such as dynamic random access memory (DRAM), static random access memory (SRAM), etc.) and nonvolatile memory elements (e.g., ROM, erasable programmable read only memory (EPROM), electronically erasable programmable read only memory (EEPROM), programmable read only memory (PROM), tape, compact disc read only memory (CD-ROM), disk, diskette, cartridge, cassette or the like, etc.). Moreover, the memory 920 may incorporate electronic, magnetic, optical, and/or other types of storage media. Note that the memory 920 can have a distributed architecture, where various components are situated remote from one another, but can be accessed by the processor 910.

The software in the memory 920 may include one or more separate programs, each of which comprises an ordered listing of executable instructions for implementing logical functions. The software in the memory 920 includes a suitable operating system (O/S) 950, compiler 940, source code 930, and one or more applications 960 in accordance with exemplary embodiments. As illustrated, the application 960 comprises numerous functional components for implementing the features and operations of the exemplary embodiments. The application 960 of the computer 900 may represent various applications, computational units, logic, functional units, processes, operations, virtual entities, and/or modules in accordance with exemplary embodiments, but the application 960 is not meant to be a limitation.

The operating system 950 controls the execution of other computer programs, and provides scheduling, input-output control, file and data management, memory management, and communication control and related services. It is contemplated by the inventors that the application 960 for implementing exemplary embodiments may be applicable on all commercially available operating systems.

Application 960 may be a source program, executable program (object code), script, or any other entity comprising a set of instructions to be performed. When a source program, then the program is usually translated via a compiler (such as the compiler 940), assembler, interpreter, or the like, which may or may not be included within the memory 920, so as to operate properly in connection with the O/S 950. Furthermore, the application 960 can be written as an object oriented programming language, which has classes of data and methods, or a procedure programming language, which has routines, subroutines, and/or functions, for example but not limited to, C, C++, C#, Pascal, BASIC, API calls, HTML, XHTML, XML, ASP scripts, FORTRAN, COBOL, Perl, Java, ADA, .NET, and the like.

The I/O devices 970 may include input devices such as, for example but not limited to, a mouse, keyboard, scanner, microphone, camera, etc. Furthermore, the I/O devices 970 may also include output devices, for example but not limited to a printer, display, etc. Finally, the I/O devices 970 may further include devices that communicate both inputs and outputs, for instance but not limited to, a NIC or modulator/demodulator (for accessing remote devices, other files, devices, systems, or a network), a radio frequency (RF) or other transceiver, a telephonic interface, a bridge, a router, etc. The I/O devices 970 also include components for communicating over various networks, such as the Internet or intranet.

If the computer 900 is a PC, workstation, intelligent device or the like, the software in the memory 920 may further include a basic input output system (BIOS) (omitted for simplicity). The BIOS is a set of essential software routines that initialize and test hardware at startup, start the O/S 950, and support the transfer of data among the hardware devices. The BIOS is stored in some type of read-only-memory, such as ROM, PROM, EPROM, EEPROM or the like, so that the BIOS can be executed when the computer 900 is activated.

When the computer 900 is in operation, the processor 910 is configured to execute software stored within the memory 920, to communicate data to and from the memory 920, and to generally control operations of the computer 900 pursuant to the software. The application 960 and the O/S 950 are read, in whole or in part, by the processor 910, perhaps buffered within the processor 910, and then executed.

When the application 960 is implemented in software it should be noted that the application 960 can be stored on virtually any computer readable storage medium for use by or in connection with any computer related system or method. In the context of this document, a computer readable storage medium may be an electronic, magnetic, optical, or other physical device or means that can contain or store a computer program for use by or in connection with a computer related system or method.

The application 960 can be embodied in any computer-readable storage medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable storage medium” can be any means that can store the program for use by or in connection with the instruction execution system, apparatus, or device. The computer readable storage medium can be, for example but not limited to, an electronic, magnetic, optical, electromagnetic, or semiconductor system, apparatus, or a device.

More specific examples (a nonexhaustive list) of the computer-readable storage medium may include the following: an electrical connection (electronic) having one or more wires, a portable computer diskette (magnetic or optical), a random access memory (RAM) (electronic), a read-only memory (ROM) (electronic), an erasable programmable read-only memory (EPROM, EEPROM, or Flash memory) (electronic), an optical fiber (optical), and a portable compact disc memory (CDROM, CD R/W) (optical). Note that the computer-readable storage medium could even be paper or another suitable medium, upon which the program is printed or punched, as the program can be electronically captured, via for instance optical scanning of the paper or other medium, then compiled, interpreted or otherwise processed in a suitable manner if necessary, and then stored in a computer memory.

In exemplary embodiments, where the application 960 is implemented in hardware, the application 960 can be implemented with any one or a combination of the following technologies, which are well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

The technical effects and benefits of exemplary embodiments include flexible allocation of address ranges in a highly-available computer system.

The terminology used herein is for the purpose of describing particular embodiments only and is not intended to be limiting of the invention. As used herein, the singular forms “a”, “an”, and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

1. A computer-implemented method for a linked list for memory allocation, comprising:
maintaining, by a memory allocation module in a computer processor, a linked list of address ranges in a computer memory that are available for allocation;
receiving, by the memory allocation module, a request for allocation of a first address range from a first operation, the request comprising a size of the first address range; and
traversing the linked list to determine an available address range having a size that is greater than or equal to the size of the first address range;
determining whether there is interference in the linked list from a second operation;
based on determining that there is no interference in the linked list from the second operation, removing determined address range from the linked list; and
based on determining that there is interference in the linked list from the second operation, restarting the traversing of the linked list.

2. The method of claim 1, further comprising:
receiving, by the memory allocation module, an indication that a second address range that was allocated to a third operation in the computer memory has been deallocated;
traversing the linked list to determine an insertion location based on a range start address of the second address range;
determining whether there is interference in the linked list from a fourth operation;
based on determining that there is no interference in the linked list from the fourth operation, inserting the second address range into the linked list at the insertion location; and
based on determining that there is interference in the linked list from the second operation, restarting the traversing of the linked list.

3. The method of claim 1, wherein the linked list comprises a plurality of nodes, each of the plurality of nodes representing a continuous available address range in the computer memory, each of the plurality of nodes comprising:
a range start address;
a range end address; and
a next pointer; wherein the plurality of nodes are sorted such that a range end address of a first node of the plurality of nodes is less than a range start address of a second node of the plurality of nodes that is referenced by the next pointer of the first node.

4. The method of claim 3, further comprising:
determining by the memory allocation module whether the range end address of the first node is contiguous with the range start address of the second node; and
based on determining that the range end address of the first node is contiguous with a range start address of the second node, consolidating the first node and the second node into a single node.

5. The method of claim 3, wherein removing the determined address range from the linked list comprises adding the size of the first address range to the range start address of a third node in the linked list that corresponds to the determined address range.

6. The method of claim 5, further comprising determining whether the third node is empty; and based on determining that the third node is empty:
marking the next pointer of the third node for removal; and
removing the third node from the linked list.

7. The method of claim 6, wherein determining that the third node is empty comprises determining that the range start address and the range end address of the third node are equal.

8. The method of claim 1, wherein determining whether there is interference in the linked list from the second operation comprises determining whether a value that is stored in the linked list is equal to an expected value.
